(19) United States
(12) Patent Application Publication
(10) Pub. No.: US 2009/0225463 A1
(43) Pub. Date: Sep. 10, 2009

(54) Method for Playing Media File Without Interruption

(76) Inventors: Hiroshi Itoh, Sagamihara-shi (JP); Atsushi Kumaki, Zushi-shi (JP); Tin-Lup Wong, Chapel Hill, NC (US); Susumu Shimotono, Hadano-shi (JP)

Correspondence Address: DILLON & YUDELL LLP, 8911 N. CAPITAL OF TEXAS HWY, SUITE 2110, AUSTIN, TX, 78759, US

(21) Appl. No.: 12/390,589

(22) Filed: Feb. 23, 2009

(30) Foreign Application Priority Data
Mar. 7, 2008 (JP) 2008-057230

(51) Int. Cl. G11B 5/02

(52) U.S. Cl. 360/55; G9B/5.026

(57) ABSTRACT

A method for playing a media file from a hard disc drive (HDD) within a portable personal computer without interruption is disclosed. The portable type personal computer is provided with an impact protection system for the HDD. A media player plays a media file by reading a group of data blocks constituting the media file out of the HDD in order. The media player invokes a function for reading any of the data blocks into a buffer. The function is hooked by a media driver, and the media driver writes a data block that has a larger size than the data blocks in a media cache, in response to an operation to read any of the data blocks. The media player then plays the data blocks transferred from the media cache to a buffer region.

### PRIORITY CLAIM

The present application claims benefit of priority under 35 U.S.C. §§120, 365 to the previously filed Japanese Patent Application No. JP2008-057230 entitled, “Method of playing media file without interruption” with a priority date of Mar. 7, 2008, which is incorporated by reference herein.

### BACKGROUND OF THE INVENTION

1. Technical Field

The present invention relates to media files in general, and in particular to a method for playing media files from a hard disc drive within a portable personal computer without interruption.

2. Description of Related Art

A software program, such as a media player, for playing a media file is often installed in a notebook type personal computer (notebook PC). Media files are typically large in size, so they are usually stored in hard disc drives (HDDs) or optical disc drives (ODDs).

In a notebook PC, hardware resources such as memories are shared by various software components so that the media player cannot appropriate the hardware resources for playing large media files. Therefore, in the media player installed in a notebook PC, a media file is divided into data blocks having a predetermined size so that the data blocks are continuously played while reading them out of a HDD into a buffer having a relatively small capacity provided to a main memory in order.

Since a notebook PC may be used on a user's lap in an automobile or an airplane, it is very susceptible to vibration or impact during usage. The HDD is configured to write/read data to/from a disc while a head slider floats on a rotating disc with an extremely small gap between them. When a large impact or vibration is applied to the notebook PC while the head slider is floating on the disc, the head may contact the disc and the written data may be lost or the disc may be damaged. Therefore, an impact protecting system is often installed in the notebook PC for protection of the HDD.

The impact protecting system causes the head slider to retreat to a ramp mechanism provided at the outer side than the outer circumference of the disc upon detecting an acceleration or a large vibration from which a dropping of the notebook PC is expected. When the impact protecting system operates during playing of the media file, the reading of the media file out of the HDD to the main memory is temporarily stopped. It has been reported that as a consequence, data buffered in the main memory is used up so that data cannot be supplied to the media player, and thus, the music or the moving image is temporarily stopped.

Some media players are configured to start playing a media file after the entire media file has been read out of a HDD to a main memory. However, since this is limited to the case where the available media file is relatively small in size or the case where the buffer can be appropriated, such a method is not employed in notebook PCs. Moreover, an operating system (OS) installed in a notebook PC is provided with a cache function wherein data read out of a HDD is pre-fetched (read-ahead) to a RAM disc provided in a main memory. However, since the RAM disc has a capacity limitation and the cache function of the OS is intended for all the data read out of the HDD, it cannot be guaranteed that the media file is filled in the RAM disc during the playing of the media file. As a result, the play operation may be interrupted when the impact protecting system operates.

Consequently, it would be desirable to provide a method for reading a media file out of a HDD within a portable type personal computer provided with an impact protecting system, and for playing the media file without interruption.

### SUMMARY OF THE INVENTION

In accordance with a preferred embodiment of the present invention, in response to a beginning data block of a media file being present within a media cache region of a main memory, the beginning data block is written to a designated address within a buffer region of the main memory. After the beginning data block has been written to the buffer region, the subsequent data blocks of the media file are written from a hard disk drive to the media cache region in corresponding data fragments, each having a size that in an integral fraction of the size of each of the subsequent data blocks. Also, a data block will be written from the media cache region to the buffer region when corresponding data fragments in the media cache region add up to the one data block. In addition, a media player program begins a play operation on the media file out of the data blocks from the buffer region.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a notebook personal computer;

FIG. 2 explains a method for reading a media file according to a preferred embodiment of the present invention;

FIG. 3 is a block diagram of a media driver;

FIG. 4 is a flow chart of a method for playing a media file according to a preferred embodiment of the present invention;

FIGS. 5A-5C explains the unit of the data of a media file requested by a media player and the unit of the media file cached by the media driver; and

FIG. 6 is a flow chart of a method for playing a media file according to an alternative embodiment of the present invention.

### DETAILED DESCRIPTION OF A PREFERRED EMBODIMENT

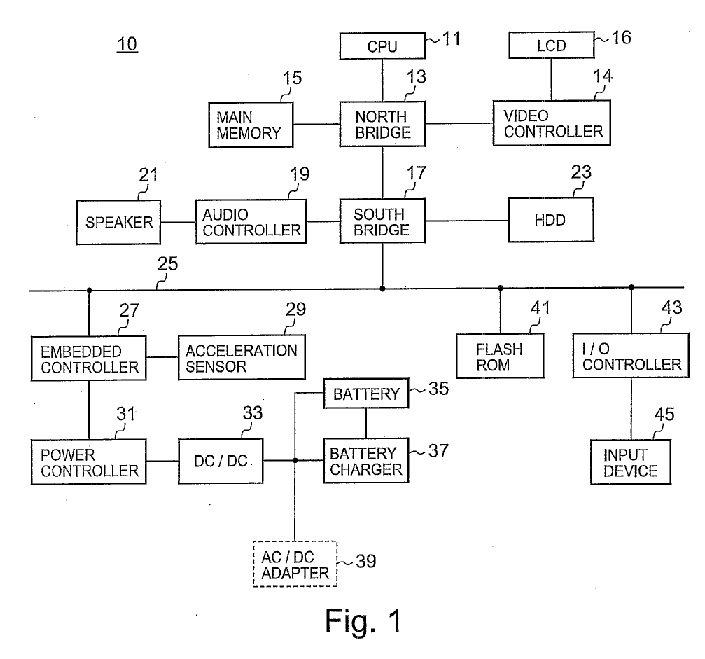

Referring now to the drawings and in particular to FIG. 1, there is depicted a block diagram of a notebook personal computer (notebook PC) 10. A central processing unit (CPU) 11 is an arithmetic processing device performing the central function of the notebook PC 10 and executes an operating system (OS), a BIOS, a device driver, or application programs. A play operation of a media player can also be executed by the CPU 11. The CPU 11 controls a north bridge 13 and devices connected to the north bridge 13 via various buses. The north bridge 13 has a memory controller function for controlling an operation of accessing a main memory 15, a data buffer function for absorbing a difference in a data transfer rate between the CPU 11 and other device, and the like.

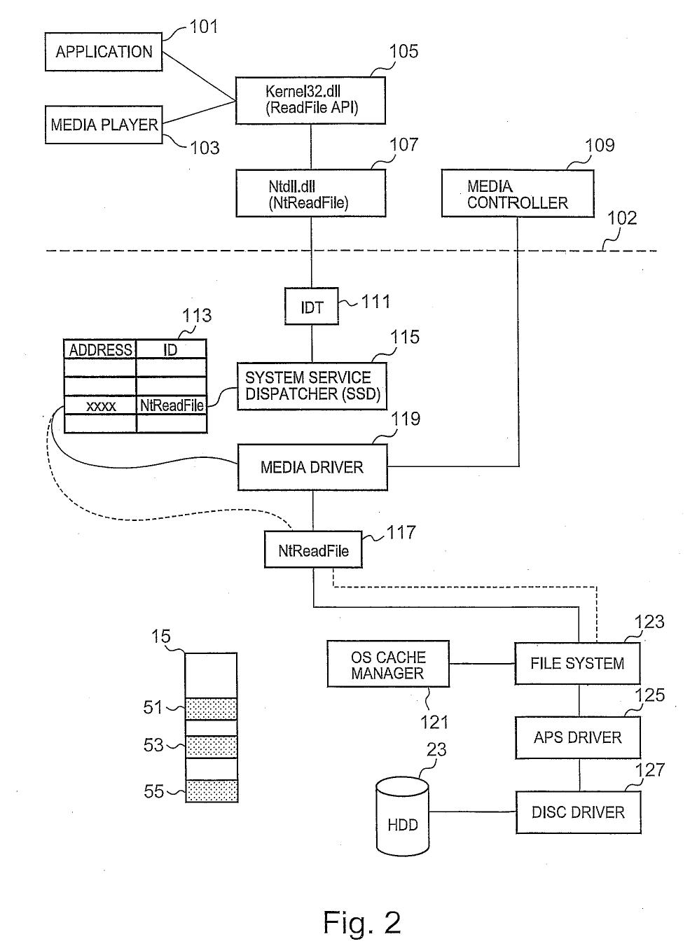

The main memory 15 is a non-volatile random access memory (RAM) used as a read area of programs executed by the CPU 11 and a work area to which processed data are written. As illustrated in FIG. 2, the main memory 15 is provided with an OS cache region 55 in which a cache function of the OS is realized, a media cache region 53 in which a cache function of the present invention is provided, and a buffer region 51 in which played data of a media player 103 is stored. The media cache region 53 may be configured as a specialized memory not as a part of the main memory 15. A video controller 15 is connected to the north bridge 13, provided with a graphic accelerator and a VRAM, and configured to receive a command from the CPU 11 to produce images of an image file to be drawn and write the images in the VRAM and to deliver images read out of the VRAM to a liquid crystal display (LCD) 16 as a drawing data. A moving image played by the media player is displayed on the LCD 16.

A south bridge 17 is connected to the north bridge 13 and is provided with interfaces for various peripheral input/output devices and ports for a PCI bus and a PCI-Express bus. The south bridge 17 is connected to an audio controller 19 and a HDD 23. The audio controller 19 converts a digital audio signal received via the south bridge 17 to an analog audio signal and delivers the analog audio signal to a speaker 21. Audio played by the media player is output through the speaker 21. In the HDD 23, a cache controller 109 (see FIG. 2) and a media driver 119 (see FIG. 2) which are software programs according to the present embodiment, as well as well-known programs such as an OS, a device driver, an application, a media player, or a media file are stored.

The south bridge 17 is also connected via a PCI bus or an LPC bus 25 to legacy devices which have been used in the notebook PC 10 from the past or devices not requiring high-speed data transmission. The LPC bus 25 is connected to an embedded controller (EC) 27, an I/O controller 43, and a flash ROM 41 storing a BIOS. The EC 27 is a microcomputer configured by an 8 to 16 bit CPU, a ROM, a RAM, and the like, and is further provided with an multi-channel A/D input terminal, a multi-channel D/A output terminal, a timer, and a digital input/output terminal. The EC 27 is connected to a power controller 31 for controlling an acceleration sensor 29 and a power supply unit via such input/output terminals and is thus able to execute a program for managing an internal operating environment of the notebook PC 10 independently of the CPU 11.

The acceleration sensor 29 detects an acceleration occurring to a casing of the notebook PC 10 to output the acceleration to the EC 27 as an analog signal. The EC 27 converts the acceleration information received from the acceleration sensor 29 to a digital signal and stores the digital signal in an internal RAM. The EC 27 and the power controller 31 are connected by a Serial Peripheral Interface (SPI) that is a specialized bus.

The power controller 31 is connected to a DC-DC converter 33. The DC-DC converter 33 converts DC electric power supplied from an AC/DC adapter 39 or a battery 35 to a plurality of voltages necessary for operating the notebook PC 10 and then supplies electric power to respective devices based on electric power supply categories defined in accordance with a power supply mode. The AC/DC adapter 39 has a primary side thereof connected to a commercial power supply to thereby convert an AC voltage to a DC voltage and a secondary side thereof configured to be detachably connected to the notebook PC 10. When the AC/DC adapter 39 is connected to the notebook PC 10, it supplies electric power to the DC-DC converter 33 and a battery charger 37 charging the battery 35. When the notebook PC 10 is used in a mobile environment, it is supplied with electric power from the battery 35 while connection of the AC/DC adapter 39 to the notebook PC 10 is removed.

The I/O controller 43 is connected to an input device 45 such as a keyboard or a mouse. The flash ROM 41 is a non-volatile memory, in which the stored contents are electrically rewritable, and stores therein a system BIOS, which is a basic program used for activation and management of a system; various utilities, which are software programs for managing power supply, temperature of a casing, and the like, a POST (Power-On Self Test), which is a software program for testing or initializing hardware components when the notebook PC 10 is activated.

FIG. 2 explains a method for reading a media file according to the present embodiment. In FIG. 2, Windows® OS is used as an example of an OS, and only the main software and hardware components related to reading of a media file are illustrated. However, the present invention is not limited to a case where the OS is the Windows® OS but may be applied to other well-known OS within the spirit of the present invention. In FIG. 2, components other than a media controller 109, a media driver 119, and a media cache region 53 are well-known components. Software components depicted above the line 102 are executed in user mode of CPU 11, while software components depicted below the line 102 are executed in kernel mode.

An application 101 and a media player 103 are able to read various files stored in the HDD 23 by a user accessing the HDD 23 through an interface of the LCD 16 and the input device 45. The application 101 processes files other than the media file, and the media player 103 read the media file to thereby output an audio or a moving image through the speaker 21 and the LCD 16. When the media file is played, the media player 103 reads data blocks having the same size into the buffer region 51 of the main memory 15 in a FIFO manner or a ring-buffer manner in order of the playing so that the played data is not interrupted.

The present invention may be applied to a media player that reads out data blocks having different sizes in order of the playing. The media file can be specified by an extension of its file name. For example, moving image files are appended with extensions such as mpg/mpeg, vob, mp4, m4v, m4a, wmv, asf/asx, mov, rm/ram, 3gp, 3g2, flv, mqv or wvx. Moreover, music files are appended with extensions such as wav, mid, mp3, wma, aif, mld, kmf, mmf, oma, flac or m3u.

Kernel32.dll is a part of a subsystem Dynamic Link Library (DLL) of the Windows® OS and converts a public Windows API function to an invoke to a non-public kernel mode system service. For example, when the application 101 or the media player 103 reads a file out of the HDD 23 into the main memory 15, a function public to an application called ReadFile API is read, followed by invoking of an internal function called NtReadFile defined in a non-public Ntoskrnl.exe, and data is output from the HDD 23.

Ntdll.dll is a support library that offers a function for use of subsystem DLLs. The Ntdll.dll is configured by internal support functions, for example, an interface function (such as System Service Dispatch Stub) which can be invoked from user mode, and a NtReadFile function which is used by a subsystem DLL. An interrupt dispatch table (IDT) 111 is expanded to the main memory 15 by an OS, and stores, in each entry, addresses for the application 101 or the media player 103 to implement software interrupts so as to transition to predetermined system services.

For example, when system service numbers are set to an EAX register of the CPU 11 to designate an index of an entry as INT 0×2eₕₑₓ, the control of the CPU 11 can be transitioned from user mode to kernel mode by implementing a system service dispatcher (SSD) 115 which is a system service of the address stored in the entry.

The SSD 115 is a part of the Ntoskrnl.exe and is configured to copy an argument (also called parameter) of an original code by invoking from the thread's user-mode stack to its kernel-mode stack. The SSD 115 implements the invoked system service by referring to the entry of a system service dispatch table (SSDT) 113. In the SSDT 113, an ID of the system service and the beginning address of a code describing the corresponding system service are stored. For example, in any entry, information representing a NtReadFile function is stored as an ID, and the address on the main memory 15, in which an actual code of the NtReadFile function 117 is memorized, is stored as an address. The NtReadFile function 117 is a part of the Ntoskrnl.exe.

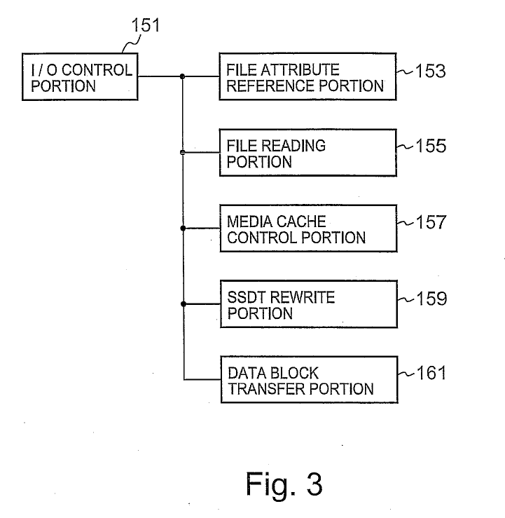

The configuration of the media driver 119 is described in details in FIG. 3. The media controller 109 provides a user interface allowing a user to set parameters of the media driver 119 via the LCD 16 and the input device 45. The user is allowed to designate, by the use of a window created by the media controller, the types of media files to be filled in the media cache region 53, the size of data to be read, and the like. A file system 123 is a software program offered by the OS for management of data written in the HDD 23. The file system 123 generates a File Allocation Table (FAT) and directories to manage writing, reading, deleting, moving, or the like of files with respect to the HDD 23.

An OS cache manager 121 is a software program offered by the OS for improvement of access performance with respect to the HDD 23. The OS cache manager 121 pre-fetches data to be filled in the OS cache region 55 so that processing can be performed even when an access is not made to the HDD 23 whenever the ReadFile API function or the WriteFile API function is invoked with respect to the HDD 23. The OS cache manager 121 manages filling and flushing of files with respect to the OS cache region 55 based on its unique algorithm, for accesses to the HDD 23 from all the software programs executed in the notebook PC 10. Filling new data in the media cache region 53 or the OS cache region 55 or flushing old data at that time is referred to as caching.

Active Protection System (APS) is a well-known impact protecting system for the HDD 23, and is configured by the acceleration sensor 29 and an APS driver 125. The APS driver 125 applies a special algorithm to an acceleration signal detected by the acceleration sensor 29, and when it is expected that a serious impact occurs to the notebook PC 10, generates a stop signal to be delivered to the HDD 23. Having received the stop signal, the HDD 23 causes a head slider to retreat to a ramp mechanism against an impact, upon completion of processing of a command previously sent from the OS through the disc driver 127, thereby protecting data and the disc from the impact. While the head slider is retreated to the ramp mechanism, the commands from the CPU 11 accessing the HDD 23 are not executed.

The APS driver 125 expands a queue to the main memory 15 to thereby queue commands sent for accessing the HDD 23 after production of the stop signal, and transfers the queued commands to the disc driver 127 after the stop signal is released. The disc driver 127 is a software program for controlling the data transfer and the operations of the HDD 23.

FIG. 3 is a block diagram illustrating a main configuration of the media driver 119. An I/O control portion 151 performs interfacing functions with respective internal and external components. A file attribute reference portion 153 makes inquires to the file system 123, by issuing a function called NtQuerySystemInformation, for example, as to whether or not a file corresponding to a handle name defined in the NtReadFile function is a media file, when the ReadFile API function is invoked by the application 101 or the media player 103.

A file reading portion 155 implements the NtReadFile function corresponding to the ReadFile API function. The file reading portion 155 implements the NtReadFile function with respect to the media file by setting an argument different from the argument designated by the media player 103 while executing the NtReadFile function with respect to files other than the media file without changing the argument designated by the application 101.

If it is determined by the file attribute reference portion 153 that the file to be read by the ReadFile API function is the media file, the file reading portion 155 divides the media file to thereby produce a system thread for filling the file in the media cache region 53. The system thread is a special thread running only in the kernel mode unlike user-mode threads. Moreover, if it is determined by the file attribute reference portion 153 that a list of the list file to be read by the ReadFile API function contains the media file, the file reading portion 155 produces a system thread for filling the media file in the media cache region 53.

A media cache control portion 157 caches the media file read from the HDD 23 by the file reading portion 155 in the media cache region 53 in a FIFO manner or a ring-buffer manner. When the file reading portion 155 has divided the media file into a plurality of data fragments, each data fragment being smaller in a size thereof than the data block, read the divided data fragments out of the HDD 23, and filled them in the media cache region 53, the media cache control portion 157 combines the respective data fragments into the size of the data block.

When the media driver 119 is loaded onto the main memory 15 together with the OS, an SSDT rewrite portion 159 rewrites the address corresponding to the ID described as the NtReadFile function in the SSDT 113, from the address of the NtReadFile function 117 to the address of the media driver 119. Such rewriting of the address of the SSDT 113 from the address of the function preset by the OS to the address of another code is referred to as hooking of a function. A data block transfer portion 161 determines whether or not the data block designated by the ReadFile API function invoked by the media player 103 to read the data block into the buffer region 15 is filled in the media cache region 53, and when the data block is filled, transfers the data block to the buffer region 51. When it is determined that the data block is not filled, the data block transfer portion 161 hands over the processing to the file reading portion 155, and then, the file reading portion 155 implements the NtReadFile function to thereby read the media file out of the HDD 23 using the method according to the present embodiment. The configuration of the media driver 119 illustrated in FIG. 3 is presented for the purpose of illustration, and any other configuration capable of realizing the equivalent function may be employed within the range obvious to those of ordinary skill in the art.

A play operation for the media file by the media player 103 is illustrated in FIG. 2. In the SSDT 113, when the ID of the NtReadFile function is designated by the SSD 115, as indicated by the dotted line, an address is set so that the NtReadFile function 117 is implemented. The media player 103 implements a play operation while dividing the media file into data blocks having a predetermined size and reading them into the buffer region 51 in order. At this time, when the ReadFile API function is invoked with respect to each data block, the corresponding NtReadFile function 117 is implemented in the OS's kernel. For each ReadFile API function, the size of the data block to be read, an offset value from the beginning position of the media file, the memorized address of the buffer region 51, and the like are set as arguments by the media player 103.

The NtReadFile function 117 is continuously implemented to correspond to the ReadFile API function invoked with respect to each data block, and when the APS driver 125 is not producing the stop signal, the data blocks are read out of the HDD 23 in order to be stored in the buffer region 51. The OS cache manager 121 provides a service to the entire applications as well as the media player 103. Therefore, the data block of the media file may be filled in the OS cache region 55 or may be flushed after being filled. The data block filled in the OS cache region 55 may be written in the buffer region 51 from the OS cache region 55. Therefore, as long as the data block is filled in the OS cache region 55, even when the APS driver 125 generates a stop signal, data supplied to the buffer region 51 is not likely to be interrupted.

However, since the OS cache region 55 is not configured as a specialized cache for the media file, when the data filled in the OS cache region 55 competes against each other depending on the number of applications 101 accessing the HDD 23 and/or the amount of data, the data block of the media file may be flushed from the OS cache region 55. Thus, after the media file has been flushed from the OS cache region 55, and if the APS driver 125 generates a stop signal at such point to stop the HDD 23 from supplying data blocks to the buffer region 51, the play operation is likely to be interrupted.

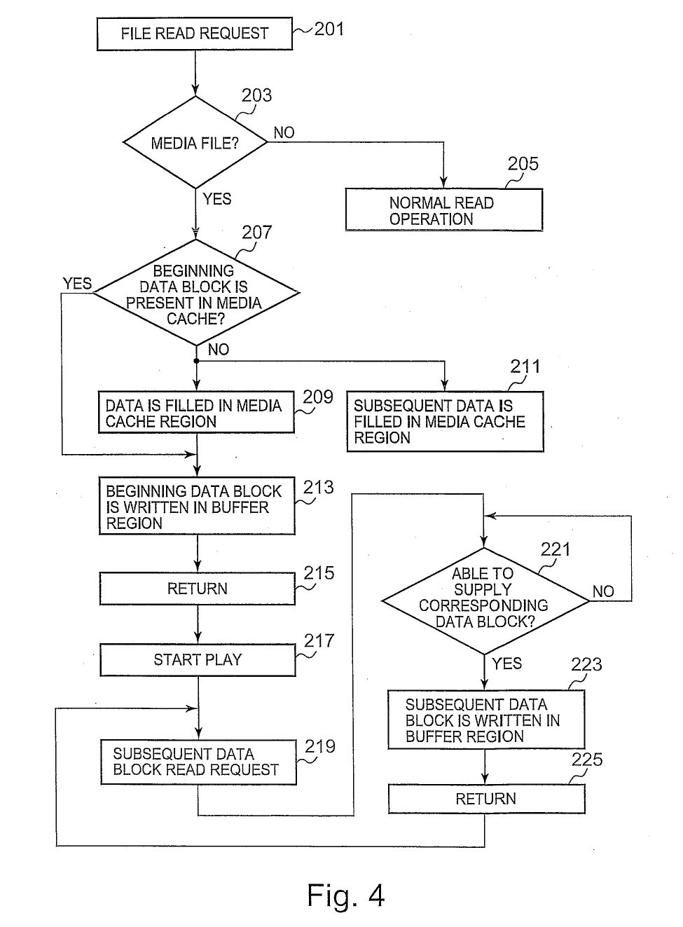

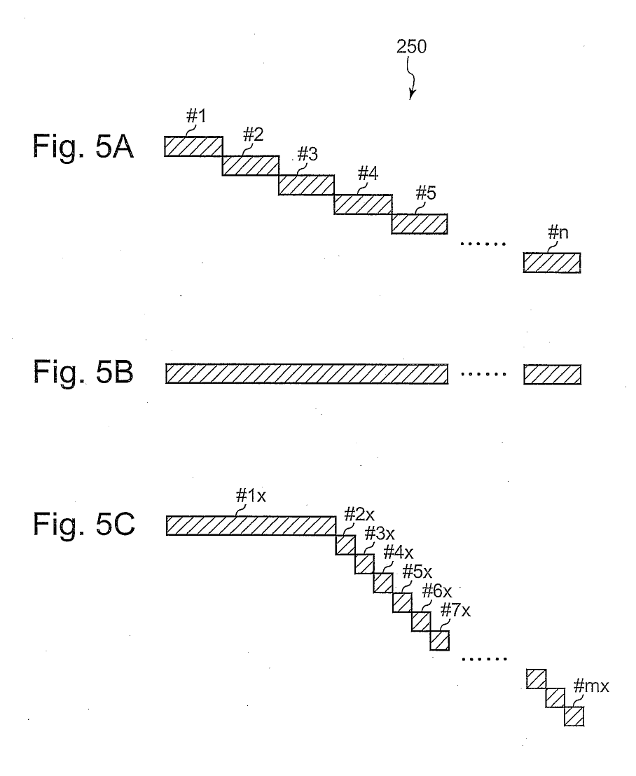

With reference now to FIGS. 4 to 5, there are depicted a method for solving the above-mentioned problem. FIG. 4 is a flow chart of a method for playing media files according to the present invention. FIG. 5A illustrates the unit (data block) of data of the media file 250, requested by the media player 103. FIGS. 5B and 5C illustrate the unit of the media file 250 cached to the media cache region 53 by the media driver 119. As illustrated in FIG. 5A, the media player 103 divides the media file 250 into n data blocks having the same size, i.e., data blocks #1 to #n, and reads them into the buffer region 51. FIG. 5B illustrates an example where the entire media file 250 is filled in the media cache region 53, and FIG. 5C illustrates an example where the media file 250 is divided into a data cluster #1x and data fragments #2x to #mx to be placed in the media cache region 53.

The media controller 109 and the media driver 119 are loaded into the main memory 15 together with the OS before the play operation starts. The address on the main memory 15 corresponding to the ID, NtReadFile, of the SSDT 113 is hooked by the SSDT rewrite portion 159 to be rewritten from the beginning address of the NtReadFile function 117 to the beginning address of the media driver 119.

In FIG. 4, at block 201, the application 101 or the media player 103 mutually independently invokes a CreateFile API function and a ReadFile API function with respect to the file system 123 to thereby implement a request to read data from the HDD 23. The OS cache manager 121 manages caching of the OS cache region 55 independently of the caching of the media cache region 53 by the media driver 119. Although the media player 103 reads the media file 250 by dividing the file into multiple data blocks, at block 201, a read request is made to the first data block, i.e., the beginning data block #1.

Since the addresses of the SSDT 113 can be rewritten, all the ReadFile API functions invoked from the application 101 or the media player 103 are implemented by the media driver 119. As illustrated in FIG. 5A, the media player 103 request the OS to divide the media file 250 into n data blocks, from the beginning data block #1 to the last data block #n and to invoke a ReadFile API function with respect to the respective data blocks so that the data blocks are written in the buffer region 51 in order.

At block 203, the file attribute reference portion 153 makes inquires to the file system 123 as to whether or not the NtReadFile function is reading out a media file, based on the handle name of the beginning data block #1 produced by the CreateFile API function. When it is determined by the file attribute reference portion 153 that the NtReadFile function is implementing the read with files other than the media file or with a media file that is not set by the media controller 109, the process proceeds to block 205 in which a normal read operation is performed (i.e., data is not pre-fetched to the media cache region 53).

At block 205, the file reading portion 155 implements the NtReadFile function without applying any changes to the argument of the ReadFile API function invoked from the application 101. As a result, as long as the APS driver 125 is not producing the stop signal, a predetermined file is written to the designated address of the main memory 15 by the file system 123.

When it is determined by the file attribute reference portion 153 at block 203 that the file is a media file, the data block transfer portion 161 determines whether or not the beginning data block #1 of the media file 250 to be read is present in the media cache region 53, as shown in block 207. When the beginning data block #1 is present, the process proceeds to block 213 in which the data block transfer portion 161 writes the beginning data block #1 stored in the media cache region 53 to the designated address of the buffer region 51. Then, at block 215, the OS sends a return signal to the media player 103 to indicate the write completion. With respect to block 209, the beginning data block #1 is present in the media cache region 53 means that the entire media file 250 or at least the data cluster #1x is present in the media cache region 53.

Having received the return signal, the media player 103 starts the play operation, as shown in block 217. Having received the return signal for the beginning data block #1, the media player 103 invokes a ReadFile API function for writing subsequent data blocks #2 to #n into the buffer region 51 at predetermined timings, independently of the caching operation of the media driver 119, as depicted in block 219.

When it is determined by the data block transfer portion 161 at block 207 that the beginning data block #1 is not present in the media cache region 53, the media driver 119 starts filling the data in the media cache region 53, as shown in block 209. The filling to the media cache region 53 is carried out based on any of the data structures illustrated in FIG. 5B or 5C. If the media cache region 53 has a sufficiently large size, the entire media file 250 can be filled in the media cache region 53 by appropriately setting arguments with respect to the NtReadFile function as shown in FIG. 5B. By doing so, even if the APS driver 125 produces the stop signal when the media file 250 is being played, the play operation is not likely to be interrupted because data blocks can be supplied from the media cache region 53 to the buffer region 51.

However, in case of filling the entire media file, the beginning data block #1 is written in the buffer region 51 after the filling of the entire file has been completed, followed by the sending of the return signal, and then, the media player 103 can start the play operation. Therefore, there occurs a delay time until the playing is started after a user starts making a playing access to the media player 103. When the delay time is not desired or when the size of the media cache region 53 is too small to store the entire media file 250, the file reading portion 155 divides the media file 250 into the data cluster #1x and subsequent data fragments #2x to #mx and fills them in the media cache region 53, as illustrated in FIG. 5C.

The file reading portion 155 performs the operation of block 209 by setting the arguments of the NtReadFile function for reading the data block #1 as shown in FIG. 5C so that the beginning data cluster #1x has a size that is an integral multiple of the size of the data block and that the storage location corresponds to the range of the media cache region 53. In the example of FIG. 5C, the size of the data cluster #1x is set to be three times the size of a data block. In order to prevent the playing from being interrupted when the APS driver 125 produces a stop signal after the playing has been started, the size of the data cluster #1x is preferably to be as large as possible within the size range of the media cache region 53. Since the size of the data cluster #1x is an integral multiple of the size of the data block, when it is determined by the data block transfer portion 161 that the data block requested from the media player 103 is present in the media cache region 53, all the data blocks can be extracted from the data cluster #1x and transferred to the buffer region 51.

After the beginning data block #1 has been transferred to the buffer region 51 from the data cluster #1x filled in the media cache region 53, as shown in block 213, a return signal is sent to the media player 103, as depicted in block 215, and the media player 103 starts the play operation. In case of caching with the data structure illustrated in FIG. 5C, the data fragments #2x to #mx subsequent to the data cluster #1x are filled in the media cache region 53, as shown in block 211. Then, the file reading portion 155 produces new system threads for the respective data fragments #2x to #mx and fills them in the media cache region 53 in order, which is independent of the procedure of block 209.

The size of each of the data fragments #2x to #mx is set to be an integral fraction of the size of a data block. In this example, the size of each data fragment is set to one third of the size of a data block. Setting the size of each data fragment to be smaller than the size of a data block is advantageous because the operation of reading a data fragment from the HDD 23 is less likely to be interrupted when subsequent data is read under the environment where the APS driver 125 is likely to generate and release stop signals on a more frequent basis. The data subsequent to the data cluster #1x may be read out in units of a size that is equal to or larger than that of a data block.

The file reading portion 155 implements, in the new system threads, the NtReadFile functions in order by setting the size of the data fragment in the arguments and setting the media cache region 53 as the storage location so that subsequent data fragments #2x to #mx read out of the HDD 23 via the file system 123 are filled in the media cache region 53. The NtReadFile functions are produced and implemented while changing offset pointers for each data fragment, and the procedure of block 211 ends at the time when the filling of the last data fragment #mx is completed.

The size of the data fragments #2x to #mx is different from the size of the data blocks #1 to #n requested by the media player 103 and that data fragments of a media file other than the media file 250 are also filled in the media cache region 53. Moreover, the data fragments #2x to #mx are read out in separate threads, respectively, so that it cannot be said that the order of filling in the media cache region 53 is identical with the order of execution by the NtReadFile function. In order for the data block transfer portion 161 to transfer data to the buffer region 51 in units of the size of the data block requested by the media player 103, the media cache control portion 157 links pointers of the entries of the respective data fragments for each media file in the order of the media file 250 to thereby combine the data fragments #2x to #mx into the unit of the data block.

At block 221, based on the arguments set in the NtReadFile function, the data block transfer portion 161 examines as to whether or not the data block #2 subsequent to the data block #1 can be transferred to the buffer region 53 from the media cache region 53. In the example illustrated in FIG. 5B, since the entire media file 250 is filled in the media cache region 53 before the playing is started, the data block transfer portion 161 is able to transfer all the data blocks #1 to #n from the media cache region 53 to the buffer region 51. In the example illustrated in FIG. 5C, since data blocks #1 to #3 are filled in the media cache region 53 as data cluster #1x before the playing is even started, the data block #2 can be supplied to the buffer region 51. In such a case, the data block transfer portion 161 writes the data block #2 to the buffer region 51 in response to a request of the media player 103, as shown block 223.

For the present embodiment, data block #4 is constituted by data fragments #2x to #4x. When a request to read the data block #4 is issued by the media player 103, the data block transfer portion 161 determines whether or not the data block #4 is formed to be linked with the pointers of the entries of the data fragments #2x to #4x filled in the media cache region 53.

When all the data fragments #2x to #4x are present in the media cache region 53 and are linked to constitute the data block #4, the flow proceeds to block 223 where the data block #4 is written in the buffer region 51 by the data block transfer portion 161. If any of the data fragments #2x to #4x is not already in the media cache region 53, it waits until the missing data fragment has arrived. One reason why the data fragment constituting the data block #4 is not already in the media cache region 53 at this point of time can be attributed to the fact that the APS driver 125 has been sustaining a stop signal for a long period of time.

However, since the data cluster #1x is large in size, the data block transfer portion 161 is able to supply the requested data blocks #1 to #3 to the buffer region 51 from the data cluster #1x filled in the media cache region 53 in order only for a predetermined time period. Moreover, since the data fragments #2x to #mx are smaller in size than the data block and are less likely to be influenced by the operation of the APS driver 125, the media cache region 53 may not be depleted and thus the continuous playing at the media player 103 can be maintained. When the requested data blocks are written in the buffer region 51, a return signal is sent from the OS to the media player 103 at block 225 so that the media player 103 is able to play the subsequent data block.

Although the present embodiment has been described for an example where using an even, as a trigger, that the beginning data block #1 is read from the media player 103, the entire media file 250 or the data cluster #1x is filled in the media cache region 53 and then the playing is performed, reading of any of the data blocks subsequent to the data block #1 may also be used as a trigger. In such a case, it is possible to prevent interruption by the impact protecting system in the play operation, subsequent to the corresponding data block.

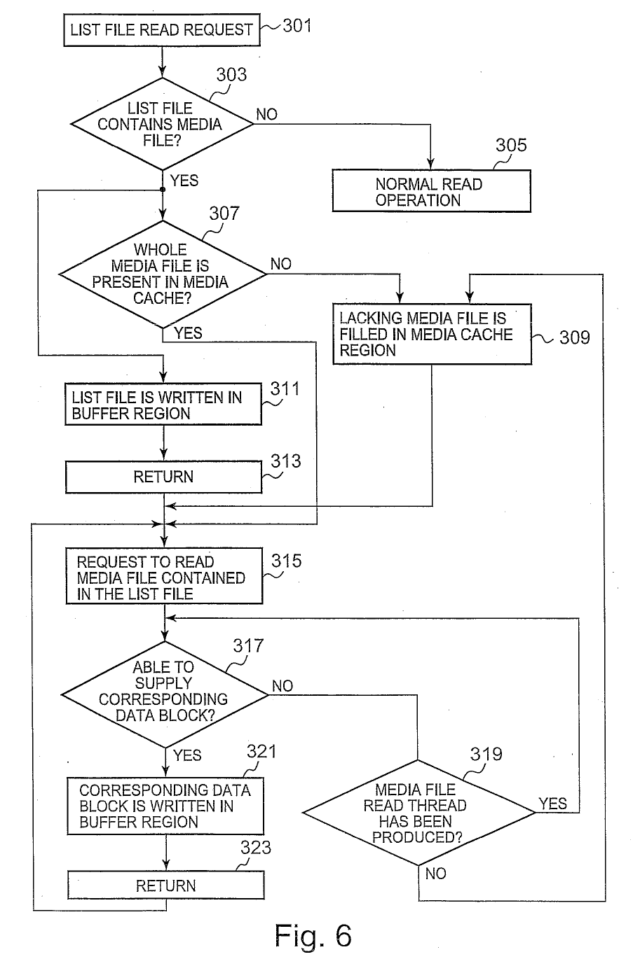

FIG. 6 illustrates an alternative method for playing a media file by the media player 103. Among files handled by the media player 103, a list file recording a playing list may be contained in any of the files. First, a user can read out the list file and then continuously play the entire media files contained in the list or selected media files in order. In the present embodiment, there is provided a method in which at a time when the list file is read, the media file is pre-fetched to the media cache region 53 with anticipation of playing of the media file so that the play operation is not interrupted even when the impact protecting system operates.

At block 301, the media player 103 invokes a CreateFile API function and a ReadFile API function with respect to the file system 123 to thereby implement a request to read a list file from the HDD 23. The NtReadFile function is hooked at the time of loading the media driver 119. At block 303, the file attribute reference portion 153 makes inquires to the file system 123 as to whether or not the NtReadFile function implemented for the read is a read of a list file containing the list of a media file, based on the handle name of the list file produced by the CreateFile API function. When it is determined by the file attribute reference portion 153 that the media file is not contained in the list of the list file, the process proceeds to block 305 where a normal read operation of the list file is performed.

When it is determined by the file attribute reference portion 153 at block 303 that the list of the list file contains the media file, the process proceeds to block 307 and block 311. At block 311, the file reading portion 155 implements the NtReadFile function using the arguments set to the ReadFile API function and writes the list file in the buffer region 51. At block 313, the OS sends a return to the media player 103. After that, the user is able to start the play operation with the entire or selected media file displayed on the LCD 16.

At block 307, the data block transfer portion 161 determines whether or not the entire media files appearing in the list of the list file are present in the media cache region 53. If the entire media files are present, the process proceeds to block 315. If it is determined by the data block transfer portion 161 at block 307 that the entire media files or any of the media files appearing in the list of the list file are not present in the media cache region 53, the process proceeds to block 309. At block 309, the file reading portion 155 produces a new system thread to implement the NtReadFile function so that the lacking media files are filled in the media cache region 53 in order. When all the lacking media files are filled, the process proceeds to block 315.

If it is determined by the media cache control portion 157 at block 307 that the entire media files appearing in the list of the list file are filled in the media cache region 53, the process proceeds to block 315. At block 315, the media player 103 issues a request to continuously read a plurality of media files for playing. The media player 103 starts a play operation with the respective media files set in the list of the list file in order by invoking the ReadFile API function for each data block as illustrated in FIG. 5A.

At block 317, the data block transfer portion 161 examines as to whether or not the beginning data block #1 of the first media file can be transferred to the buffer region 51 from the media cache region 53. When it is determined by the data block transfer portion 161 that the data block can be transferred, the process proceeds to block 321 where the beginning data block #1 is written in the buffer region 51 by the data block transfer portion 161. When the writing of the beginning data block #1 is completed, the OS sends a return signal to the media player 103 at block 323, and the play operation starts. After that, returning to block 315, the filling of data blocks in the media cache region 53 and transferring of the data block to the buffer region 51 are repeated according to the steps illustrated in FIG. 4. Since data is written from the media cache region 53 to the buffer region 51 with respect to the request for the entire data blocks, the play operation of the media player 103 is not interrupted even when the APS driver 125 produces the stop signal so that the operation of the HDD 23 is temporarily stopped.

When it is determined at block 317 that it is impossible to transfer the requested data block from the media cache region 53, the process proceeds to block 319. At block 319, the file reading portion 155 determines whether or not a system thread for filling the media file containing the corresponding data block in the media cache region 53 is produced. When the system thread is produced already and the NtReadFile function is implemented, the process proceeds to block 317 and waits. If the system thread is not yet produced, the process proceeds to block 309.

As has been described, the present invention provides a method for playing media files from a disc drive mounted in a portable computer without interruption. As a result of adopting the methods shown in FIGS. 4 and 6 (i.e., by merely adding the media driver 119 without applying any changes to the OS and the media player 103), it is possible to play a media file in a notebook PC provided with an impact protecting system without interruption.

While the invention has been particularly shown and described with reference to a preferred embodiment, it will be understood by those skilled in the art that various changes in form and detail may be made therein without departing from the spirit and scope of the invention.

What is claimed is:

1. A method comprising:
in response to a beginning data block of a media file being present within a media cache region of a main memory, writing said beginning data block to a designated address within a buffer region of said main memory; and
after said beginning data block has been written to said buffer region,
writing subsequent data blocks of said media file from a hard disk drive to said media cache region in corresponding data fragments each having a size that in an integral fraction of the size of each of said subsequent data blocks;
writing one data block from said media cache region to said buffer region when corresponding data fragments in said media cache region add up to said one data block; and
permitting a media player program to begin a play operation on said media file out of data blocks from said buffer region.

2. The method of claim 1, wherein said beginning data block in said media cache region includes an entire media file.

3. The method of claim 1, wherein said beginning data block in said media cache region includes a data cluster that is larger than a size of a data block.

4. The method of claim 3, wherein said data cluster has a size that is an integral multiple of the size of said data block.

5. The method of claim 3, wherein said media player program starts said play operation in response to a transfer of said data cluster written in said media cache region to said buffer region.

6. The method of claim 3, wherein data fragments subsequent to said data cluster have smaller sizes than said data block.

7. A portable type computer comprising:
a processor;
a main memory;
a hard disc drive for storing a media file;
an impact protection system for protecting said hard disc drive from an impact;
means for writing, in response to a beginning data block of said media file being present within a media cache region of said main memory, said beginning data block to a designated address within a buffer region of said main memory; and
after said beginning data block has been written to said buffer region,
means for writing subsequent data blocks of said media file from said hard disk drive to said media cache region in corresponding data fragments each having a size that in an integral fraction of the size of each of said subsequent data blocks;
means for writing one data block from said media cache region to said buffer region when corresponding data fragments in said media cache region add up to said one data block; and
a media player program for playing said media file out of data blocks from said buffer region.
